(19) United States
(12) Patent Application Publication
(10) Pub. No.: US 2005/0268005 A1
(43) Pub. Date: Dec. 1, 2005

(54) Multi-media displaying device

(76) Inventor: Hsiu-Chu Hsu Li, Jubei City (TW)

Correspondence Address: CHARLES E. BAXLEY, ESQ., 90 JOHN STREET, THIRD FLOOR, NEW YORK, NY, 10038, US

(21) Appl. No.: 10/854,090

(22) Filed: May 25, 2004

(51) Int. Cl. H04N 5/91

(52) U.S. Cl. 710/62; 710/14

(57) ABSTRACT

A multi-media displaying device includes a receptacle having an interface module, a processor device coupled to the interface module for signal processing purposes, a screen coupled to the processor device for signal displaying purposes, and includes a coupler. A transforming device may be selectively pluggable into the coupler of the receptacle, for selectively communicating with the processor device via the interface module, and one or more further transforming device may further be selectively plugged into the coupler of the receptacle, for selectively communicating with the processor device via the interface module.

### BACKGROUND OF THE INVENTION

1. Field of the Invention

The present invention relates to a multi-media displaying device, and more particularly to a multi-media displaying device for easily displaying various kinds of audio and/or video media.

2. Description of the Prior Art

Various kinds of typical audio and/or video media displaying devices have been developed for displaying various kinds of audio and/or video media.

For example, liquid crystal display (LCD) monitors, digital video disc (DVD) players, rotatable or openable LCD-DVD players, flat-type LCD-DVD players, and LCD-television player devices, memory card reading devices, DVD loading devices, global positioning devices or systems, etc., have been provided for loading and/or reading and/or displaying various kinds of audio and/or video media.

The users have to purchase each of the typical audio and/or video media displaying devices, to enjoy different kinds of audio and/or video media.

For allowing users to easily enjoy different or various kinds of audio and/or video media, some of the typical audio and/or video media displaying devices have been built in a single box, for playing various kinds of audio and/or video media, and for allowing users to easily enjoy different or various kinds of audio and/or video media without purchasing many of the typical audio and/or video media displaying devices.

However, when some of the typical audio and/or video media displaying devices are built in a single box, the box may include a greatly increased volume that may not be easily carried with the users. In addition, a number of interfaces or couplers are required to be disposed or engaged into the box, for plugging various kinds of audio and/or video media.

The present invention has arisen to mitigate and/or obviate the afore-described disadvantages of the conventional audio and/or video media displaying devices.

### SUMMARY OF THE INVENTION

The primary objective of the present invention is to provide a multi-media displaying device including a simplified configuration for easily plugging various kinds of audio and/or video media cards or devices, and thus for easily displaying various kinds of audio and/or video media.

The other objective of the present invention is to provide a multi-media displaying device including a simplified configuration for being easily carried with the users.

In accordance with one aspect of the invention, there is provided a multi-media displaying device comprising a receptacle including an interface module provided therein, a processor device coupled to the interface module, for processing signals from the interface module, and a screen coupled to the processor device, for displaying signals from the processor device, the receptacle including a coupler provided therein, a first transforming device selectively pluggable into the coupler of the receptacle, for selectively communicating with the processor device via the interface module, and at least one second transforming device selectively pluggable into the coupler of the receptacle, for selectively communicating with the processor device via the interface module.

The interface module may be set as intelligent driver electronics, or may be set as universal serial bus. The receptacle may include an image processing unit coupled between the processor device and the screen, and may include a pivotal stay to selectively support the receptacle in an erect position.

The receptacle includes an audio and/or video signal input interface coupled to the processor device, for imputing audio and/or video signals into the processor device, and may include an audio and/or video signal output interface coupled to the processor device, for outputting audio and/or video signals from the processor device. The receptacle may further include a stereo coupled to the processor device, for outputting audio signals.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a rear perspective view of a multi-media displaying device in accordance with the present invention;

FIG. 2 is a front plan view of the multi-media displaying device;

FIG. 3 is a side plan view of the multi-media displaying device;

FIG. 4 is a block diagram illustrating the elements of the multi-media displaying device;

FIGS. 5, 6, 7 are plan views illustrating three kinds of transforming devices for the multi-media displaying device; and

FIGS. 8, 9, 10 are end plan views of the transforming devices as shown in FIGS. 5, 6, 7 respectively.

### DETAILED DESCRIPTION OF THE PREFERRED EMBODIMENT

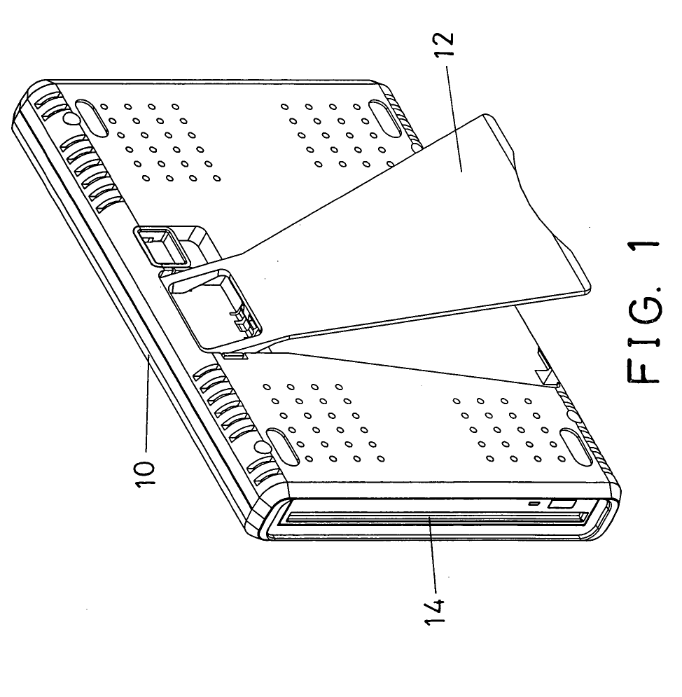

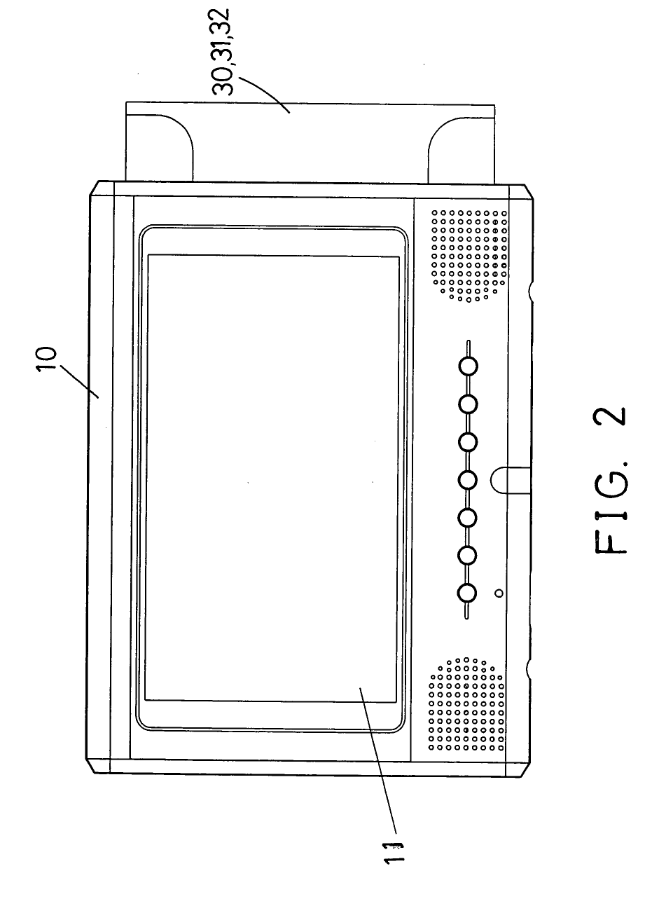

Referring to the drawings, and initially to FIGS. 1-4, a multi-media displaying device in accordance with the present invention comprises a receptacle 10 including a screen 11 formed or provided in front portion thereof, for displaying images or video signals, and including a pivotal stay 12 for selectively supporting the receptacle 10 in an erect status or position.

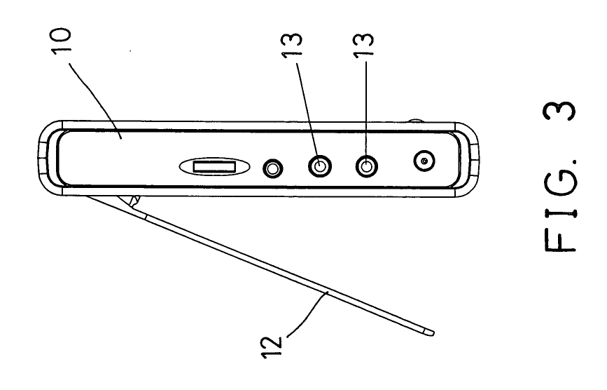

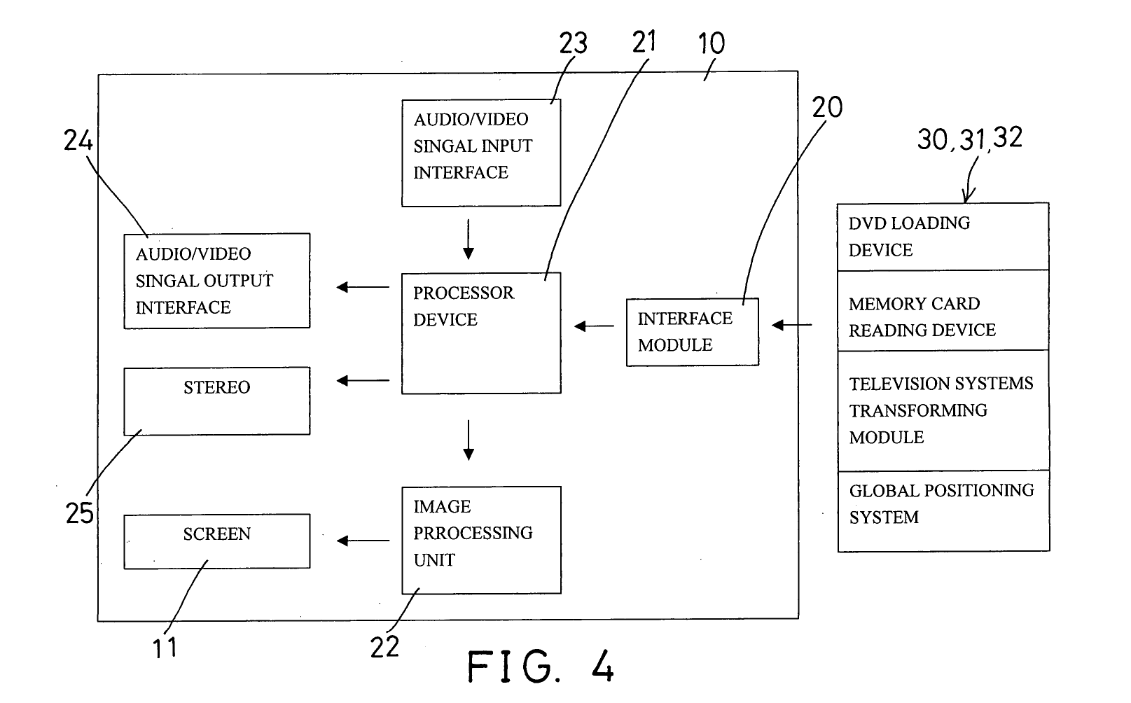

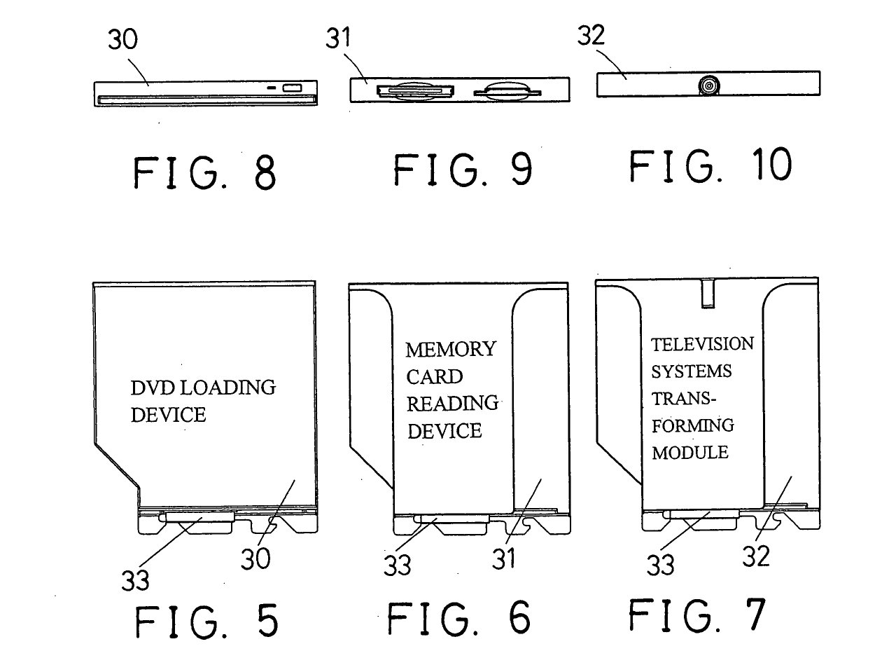

The receptacle 10 includes a number of sockets or couplers 13 (FIG. 3) formed or provided therein, for plugging or coupling various kinds of input and/or output devices, such as electric power sources, ear pieces, microphones, audio and/or video signals, etc., and includes a slot or a coupler 14 formed or provided therein for plugging various kinds of card members or transforming devices 30, 31, 32 (FIGS. 4-10).

As shown in FIG. 4, the receptacle 10 includes an interface module 20 formed or provided therein, for plugging or coupling to the card members or transforming devices 30-32, the interface module 20 may be set or provided as intelligent driver electronics (IDE), universal serial bus (USB), or the like, for coupling to and for communicating with different kinds of card members or transforming devices 30-32.

The receptacle 10 further includes an audio and/or video processor device 21 coupled to the interface module 20, for processing various signals, data, or information, and for sending or receiving the signals or data or information to and from the interface module 20, and includes an image processing unit 22 coupled to the processor device 21, for displaying images or video signals on the screen 11.

The receptacle 10 further includes an audio and/or video signal input interface 23 coupled to the processor device 21, for imputing audio and/or video signals into the processor device 21, and an audio and/or video signal output interface 24 coupled to the processor device 21, for outputting audio and/or video signals from the processor device 21. The receptacle 10 may further include a stereo 25 coupled to the processor device 21, for outputting audio signals.

Referring again to FIGS. 4-10, the card members or transforming devices 30-32 may be selected from the DVD players or loading devices 30, memory card reading devices 31, television systems transforming module 32, LCD-DVD players, global positioning devices or systems, LCD-television player devices, etc., and may be selectively or changeably coupled or plugged to the coupler 14 of the receptacle 10.

Each of the transforming devices 30-32 includes an interface or a coupler 33 for coupling to the interface module 20, and for communicating with the interface module 20, and thus for allowing the transforming devices 30-32 to be selectively or changeably coupled or plugged to the coupler 14 of the receptacle 10.

It is to be noted that the transforming devices 30-32 may be selectively or changeably coupled or plugged to the coupler 14 of the receptacle 10, and are not in-built within the receptacle 10, such that the receptacle 10 includes a compact configuration that may be easily carried with the users. In addition, the users may purchase the required or needed transforming devices 30-32 only. The interface module 20 may be coupled to and communicating with various kinds of transforming devices 30-32.

Accordingly, the multi-media displaying device in accordance with the present invention includes a simplified configuration for easily plugging various kinds of audio and/or video media cards or devices, and thus for easily displaying various kinds of audio and/or video media.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A multi-media displaying device comprising:
a receptacle including an interface module provided therein, a processor device coupled to said interface module, for processing signals from said interface module, and a screen coupled to said processor device, for displaying signals from said processor device, said receptacle including a coupler provided therein,
a first transforming device selectively pluggable into said coupler of said receptacle, for selectively communicating with said processor device via said interface module, and
at least one second transforming device selectively pluggable into said coupler of said receptacle, for selectively communicating with said processor device via said interface module.

2. The multi-media displaying device as claimed in claim 1, wherein said interface module is set as intelligent driver electronics.

3. The multi-media displaying device as claimed in claim 1, wherein said interface module is set as universal serial bus.

4. The multi-media displaying device as claimed in claim 1, wherein said receptacle includes an image processing unit coupled between said processor device and said screen.

5. The multi-media displaying device as claimed in claim 1, wherein said receptacle includes a pivotal stay to selectively support said receptacle in an erect position.

6. The multi-media displaying device as claimed in claim 1, wherein said receptacle includes an audio and/or video signal input interface coupled to said processor device, for imputing audio and/or video signals into said processor device.

7. said multi-media displaying device as claimed in claim 1, wherein said receptacle includes an audio and/or video signal output interface coupled to said processor device, for outputting audio and/or video signals from said processor device.

8. The multi-media displaying device as claimed in claim 1, wherein said receptacle includes a stereo coupled to said processor device, for outputting audio signals.
